(19) United States
(12) Patent Application Publication
(10) Pub. No.: US 2016/0249359 A1
(43) Pub. Date: Aug. 25, 2016

(54) USER TERMINAL, BASE STATION, AND PROCESSOR

(71) Applicant: KYOCERA CORPORATION, Kyoto (JP)

(72) Inventors: Chiharu YAMAZAKI, Ota-ku, Tokyo (JP); Masato FUJISHIRO, Yokohama-shi, Kanagawa (JP)

(73) Assignee: KYOCERA CORPORATION, Kyoto (JP)

(21) Appl. No.: 15/024,241

(22) PCT Filed: Sep. 24, 2014
(86) PCT No.: PCT/JP2014/075321

§ 371 Date: Mar. 26, 2016

(30) Foreign Application Priority Data
Sep. 27, 2013 (JP) 2013-202764

(51) Int. Cl. H04W 72/04; H04W 24/10; H04L 5/00; H04L 5/14

(52) U.S. Cl. CPC H04W 72/0453; H04L 5/14; H04W 24/10; H04L 5/0048

(57) ABSTRACT

Each of frequency f1 and frequency f2 has a TDD configuration that alternately has a downlink period and an uplink period. The downlink period of the frequency f1 and the uplink period of the frequency f2 are set so as to be matched on a time axis, and the uplink period of the frequency f1 and the downlink period of the frequency f2 are set so as to be matched on a time axis. UE and eNB perform downlink communication in each of the downlink periods of the frequency f1 and the frequency f2, and perform the uplink communication in each of the uplink periods of the frequency f1 and the frequency f2.

### TECHNICAL FIELD

The present invention relates to a user terminal, a base station, and a processor used in a mobile communication system.

### BACKGROUND ART

LTE (Long Term Evolution), specifications of which have been designed in 3GPP (3rd Generation Partnership Project) which is a project aiming to standardize a mobile communication system, supports Frequency Division Duplex (FDD) in which communication is performed by using a pair of a downlink frequency and an uplink frequency.

In a mobile communication system that employs the FDD (that is, an FDD communication system), a user terminal feeds back, to a base station, channel state information (CSI) indicating a channel state in the downlink frequency on the basis of a downlink reference signal that is transmitted from the base station by using the downlink frequency (for example, see Non Patent Literature 1).

The base station performs downlink transmission control on the basis of the CSI fed back from the user terminal. The downlink transmission control is, for example, downlink multi-antenna transmission control and/or a downlink scheduling.

Furthermore, in the 3GPP, introduction of a new carrier configuration (NCT: New Carrier Type) has been discussed, which is different from a conventional-type carrier configuration specified in the Releases 8 to 11.

### CITATION LIST

### Non Patent Literature

[NPL 1] 3GPP Technical Specification “TS 36.211 V11.3.0” June, 2013

### SUMMARY

In an FDD communication system, a CSI feedback is essential to perform downlink transmission control, and overhead due to the CSI feedback is a problem.

Further, an information amount of CSI that should be fed back increases because CSI with higher accuracy is needed when advancing the downlink transmission control, and overhead due to the CSI feedback is a serious problem.

Furthermore, in LTE-Advanced (LTE-A), carrier aggregation (CA) is introduced, in which a plurality of carriers (frequencies) are bundled and used for communication. However, in a specification of the LTE-A, there is another problem that a maximum frequency width available when using the CA in TDD is limited to a half of the width in the FDD.

Therefore, a first object of the present invention is to reduce the overhead due to the CSI feedback.

Furthermore, a second object of the present invention is to enable an increase in the maximum frequency width available when using the CA in a TDD carrier.

A user terminal according to a first aspect performs downlink communication and uplink communication with a base station by using a pair of a first frequency and a second frequency. Each of the first frequency and the second frequency has a TDD configuration that alternately has a downlink period and an uplink period. The downlink period of the first frequency and the uplink period of the second frequency are set so as to be matched on a time axis, and the uplink period of the first frequency and the downlink period of the second frequency are set so as to be matched on a time axis. The user terminal comprises a controller configured to perform the downlink communication in each of the downlink periods of the first frequency and the second frequency, and perform the uplink communication in each of the uplink periods of the first frequency and the second frequency.

A base station according to a second aspect performs downlink communication and uplink communication with a user terminal by using a pair of a first frequency and a second frequency. Each of the first frequency and the second frequency has a TDD configuration that alternately has a downlink period and an uplink period. The downlink period of the first frequency and the uplink period of the second frequency are set so as to be matched on a time axis, and the uplink period of the first frequency and the downlink period of the second frequency are set so as to be matched on a time axis. The base station comprises a controller configured to perform the downlink communication in each of the downlink periods of the first frequency and the second frequency, and perform the uplink communication in each of the uplink periods of the first frequency and the second frequency.

A processor according to a third aspect is provided in a user terminal that performs downlink communication and uplink communication with a base station by using a pair of a first frequency and a second frequency. Each of the first frequency and the second frequency has a TDD configuration that alternately has a downlink period and an uplink period. The downlink period of the first frequency and the uplink period of the second frequency are set so as to be matched on a time axis, and the uplink period of the first frequency and the downlink period of the second frequency are set so as to be matched on a time axis. The processor performs the downlink communication in each of the downlink periods of the first frequency and the second frequency, and performs the uplink communication in each of the uplink periods of the first frequency and the second frequency.

### BRIEF DESCRIPTION OF DRAWINGS

FIG. 1 is a configuration diagram of an LTE system according to an embodiment.

FIG. 2 is a block diagram of a UE according to the embodiment.

FIG. 3 is a block diagram of an eNB according to the embodiment.

FIG. 4 is a protocol stack diagram of a radio interface according to the embodiment.

FIG. 5 is a configuration diagram of a radio frame according to the embodiment.

FIG. 6 is a diagram for describing an operation environment according to the embodiment.

FIG. 7 is a diagram for describing an NCT according to the embodiment.

FIG. 8 is a diagram illustrating variations of a TDD frame configuration in LTE.

FIG. 9 is a diagram for describing an example of a combination of the TDD frame configurations according to the embodiment.

FIG. 10 is a sequence diagram according to the embodiment.

FIG. 11 is a sequence diagram illustrating a measurement report procedure according to the embodiment.

FIG. 12 is a sequence diagram illustrating an Ack/Nack report procedure according to the embodiment.

### DESCRIPTION OF EMBODIMENTS

### Overview of Embodiments

A user terminal according to embodiments performs downlink communication and uplink communication with a base station by using a pair of a first frequency and a second frequency. Each of the first frequency and the second frequency has a TDD configuration that alternately has a downlink period and an uplink period. The downlink period of the first frequency and the uplink period of the second frequency are set so as to be matched on a time axis, and the uplink period of the first frequency and the downlink period of the second frequency are set so as to be matched on a time axis. The user terminal comprises a controller configured to perform the downlink communication in each of the downlink periods of the first frequency and the second frequency, and perform the uplink communication in each of the uplink periods of the first frequency and the second frequency.

In the embodiments, the user terminal further comprises a transmitter configured to transmit, to the base station, an uplink reference signal that is used in channel estimation in each of the uplink periods of the first frequency and the second frequency.

In the embodiments, a single cell identifier for regarding the pair of the first frequency and the second frequency as a frequency in a single FDD configuration in or above a MAC layer is assigned to the pair of the first frequency and the second frequency.

In the embodiments, the user terminal further comprises a receiver configured to receive a downlink reference signal from the base station in each of the downlink periods of the first frequency and the second frequency; and a transmitter configured to transmit, to the base station, a measurement report that includes received power and/or reception quality of the downlink reference signal. The transmitter transmits, to the base station, the measurement report common in the pair of the first frequency and the second frequency.

In the embodiments, the user terminal further comprises a receiver configured to receive downlink user data from the base station in each of the downlink periods of the first frequency and the second frequency; and a transmitter configured to transmit an Ack/Nack for the downlink user data to the base station. The transmitter transmits, to the base station, the Ack/Nack common in the pair of the first frequency and the second frequency.

A base station according to the embodiments performs downlink communication and uplink communication with a user terminal by using a pair of a first frequency and a second frequency. Each of the first frequency and the second frequency has a TDD configuration that alternately has a downlink period and an uplink period. The downlink period of the first frequency and the uplink period of the second frequency are set so as to be matched on a time axis, and the uplink period of the first frequency and the downlink period of the second frequency are set so as to be matched on a time axis. The base station comprises a controller configured to perform the downlink communication in each of the downlink periods of the first frequency and the second frequency, and perform the uplink communication in each of the uplink periods of the first frequency and the second frequency.

In the embodiments, the base station further comprises a receiver configured to receive, from the user terminal, an uplink reference signal that is used in channel estimation in each of the uplink periods of the first frequency and the second frequency.

In the embodiments, a single cell identifier for regarding the pair of the first frequency and the second frequency as a frequency in a single FDD configuration in or above a MAC layer is assigned to the pair of the first frequency and the second frequency.

In the embodiments, the base station further comprises a transmitter configured to transmit a downlink reference signal in each of the downlink periods of the first frequency and the second frequency; and a receiver configured to receive, from the user terminal, a measurement report that includes received power and/or reception quality of the downlink reference signal. The receiver receives, from the user terminal, the measurement report common in the pair of the first frequency and the second frequency.

In the embodiments, the base station further comprises a transmitter configured to transmit downlink user data to the user terminal in each of the downlink periods of the first frequency and the second frequency; and a receiver configured to receive an Ack/Nack for the downlink user data from the user terminal. The receiver receives, from the user terminal, the Ack/Nack common in the pair of the first frequency and the second frequency.

A processor according to the embodiments is provided in a user terminal that performs downlink communication and uplink communication with a base station by using a pair of a first frequency and a second frequency. Each of the first frequency and the second frequency has a TDD configuration that alternately has a downlink period and an uplink period. The downlink period of the first frequency and the uplink period of the second frequency are set so as to be matched on a time axis, and the uplink period of the first frequency and the downlink period of the second frequency are set so as to be matched on a time axis. The processor performs the downlink communication in each of the downlink periods of the first frequency and the second frequency, and performs the uplink communication in each of the uplink periods of the first frequency and the second frequency.

### Embodiment

An embodiment of applying the present invention to the LTE system will be described below.

(System Configuration)

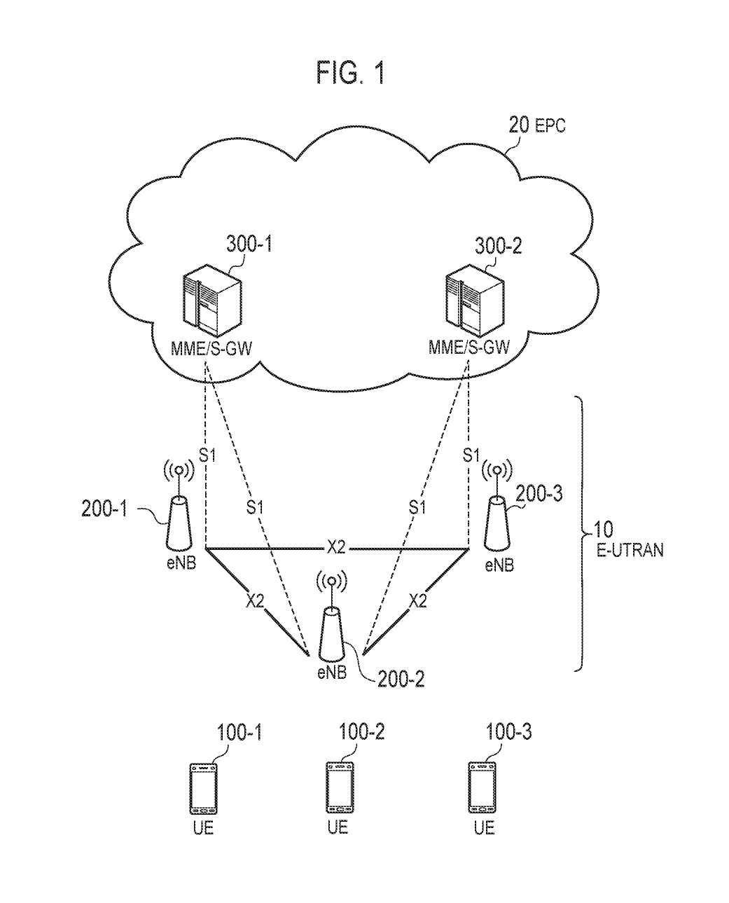

FIG. 1 is a configuration diagram of an LTE system according to an embodiment. As illustrated in FIG. 1, the LTE system includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell) with which a connection is established. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface. Configuration of the eNB 200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. A network of the LTE system is configured by the E-UTRAN 10 and the EPC 200. The EPC 20 includes a plurality of MME (Mobility Management Entity)/S-GWs (Serving-Gateways) 300. The MME performs various mobility controls and the like for the UE 100. The S-GW performs control to transfer user. MME/S-GW 300 is connected to eNB 200 via an S1 interface.

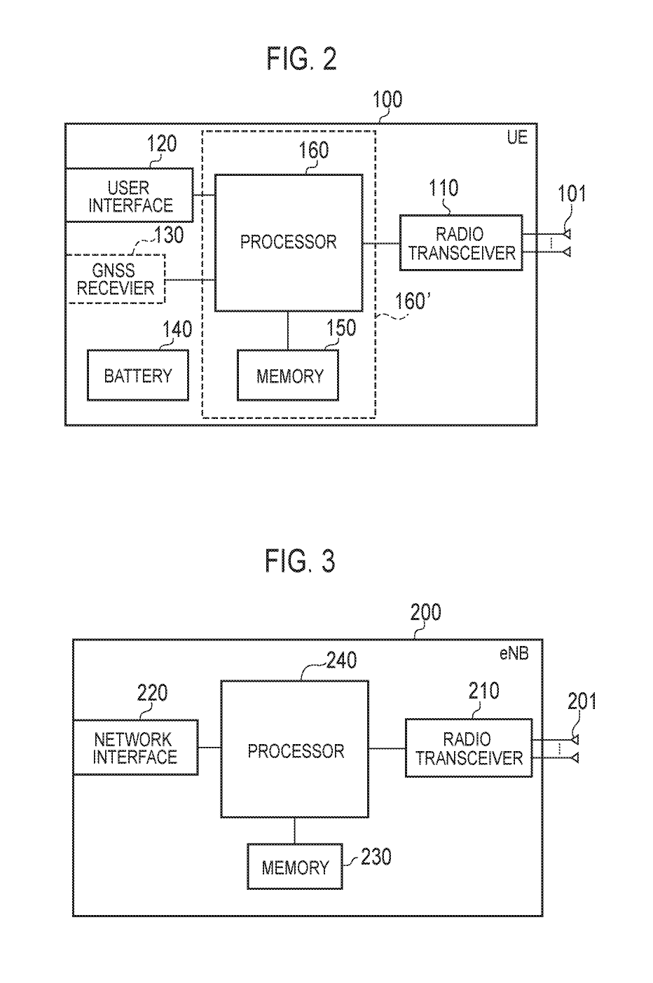

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chip set) may be called a processor 160′.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. The memory 230 and the processor 240 constitute a controller.

The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

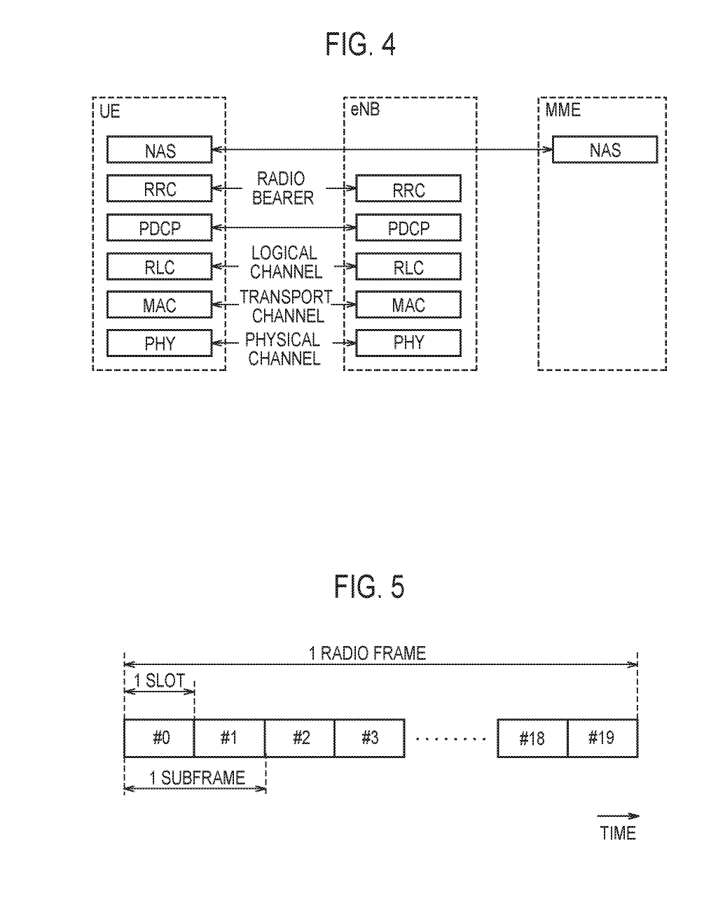

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Media Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, use data and control signal are transmitted via the physical channel.

The MAC layer performs priority control of data, a retransmission process by hybrid ARQ (HARQ), and the like. Between the MAC layer of the UE 100 and the MAC layer of the eNB 200, user data and control signal are transmitted via a transport channel. The MAC layer of the eNB 200 includes a scheduler that determines a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control message (RRC messages) for various types of configuration are transmitted. The RRC layer controls the logical channel, the transport channel, and the physical channel in response to establishment, re-establishment, and release of a radio bearer. When there is an RRC connection between the RRC of the UE 100 and the RRC of the eNB 200, the UE 100 is in a connected state (an RRC connected state), otherwise the UE 100 is in an idle state (an RRC idle state).

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. Resource element is configured by one subcarrier and one symbol.

Among radio resources assigned to the UE 100, a frequency resource is configured by a resource block and a time resource is configured by a subframe (or slot).

In the downlink, an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data.

In the uplink, both ends in the frequency direction of each subframe are control regions used as a physical uplink control channel (PUCCH) for mainly transmitting a control signal. Furthermore, the central portion in the frequency direction of each subframe is a region available as a physical uplink shared channel (PUSCH) for mainly transmitting user data.

### Operation According to Embodiment

(1) Operation Overview

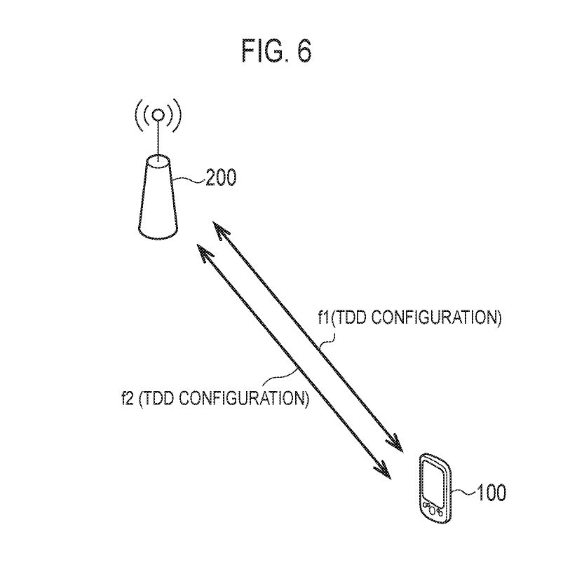

FIG. 6 is a diagram for describing an operation environment according to the embodiment.

As shown in FIG. 6, the LTE system according to the embodiment performs downlink communication and uplink communication by using a pair of a frequency f1 and a frequency f2. It is common with a general FDD communication system in that a pair of frequencies is used. Furthermore, a channel state in the frequency f1 and a channel state in the frequency f2 are different.

In the general FDD communication system, the UE 100 performs channel estimation on the basis of a downlink reference signal that is transmitted from the eNB 200 by using the downlink frequency f1, and feeds back CSI indicating a channel state in the downlink frequency f1 to the eNB 200. The downlink reference signal includes a CRS (Cell-specific Reference Signal), a CSI-RS (Channel State Information-Reference Signal), etc.

The CRS is a cell-specific downlink reference signal. The CRS and the CSI-RS are mainly used in the channel estimation to acquire the CSI (that is, CSI measurement). The CRS is also used in received power (RSRP: Reference Signal Received Power) measurement for mobility control other than the channel estimation.

The CSI includes channel quality information (CQI; Channel Quality Indicator), precoder matrix information (PMI; Precoder Matrix Indicator), rank information (RI; Rank Indicator), etc. The CQI is an index indicating a modulation and coding scheme (MCS) that is recommended in the downlink. The PMI is an index indicating a precoder matrix that is recommended in the downlink. The RI is an index indicating a rank that is recommended in the downlink.

The eNB 200 performs the downlink transmission control on the basis of the CSI fed back from the UE 100. The downlink transmission control is, for example, the downlink multi-antenna transmission and/or the downlink scheduling. For example, the eNB 200 controls the downlink multi-antenna transmission on the basis of the PMI and the RI. Furthermore, the eNB 200 performs the downlink scheduling on the basis of the CQI.

Thus, in the general FDD communication system, the CSI feedback is essential to perform the downlink transmission control, and overhead due to the CSI feedback is the problem. Further, an information amount of CSI that should be fed back increases because CSI with higher accuracy is needed when advancing the downlink transmission control, and overhead due to the CSI feedback is a serious problem. Furthermore, with current CSI accuracy, it is difficult to introduce an advanced multi-antenna transmission such as MU-MIMO (Multi User Multiple-Input Multiple-Output).

Therefore, in the embodiment, in order to resolve this problem, a new carrier configuration (NCT) is introduced, which is different from a conventional-type carrier configuration that is specified in the Releases 8 to 11.

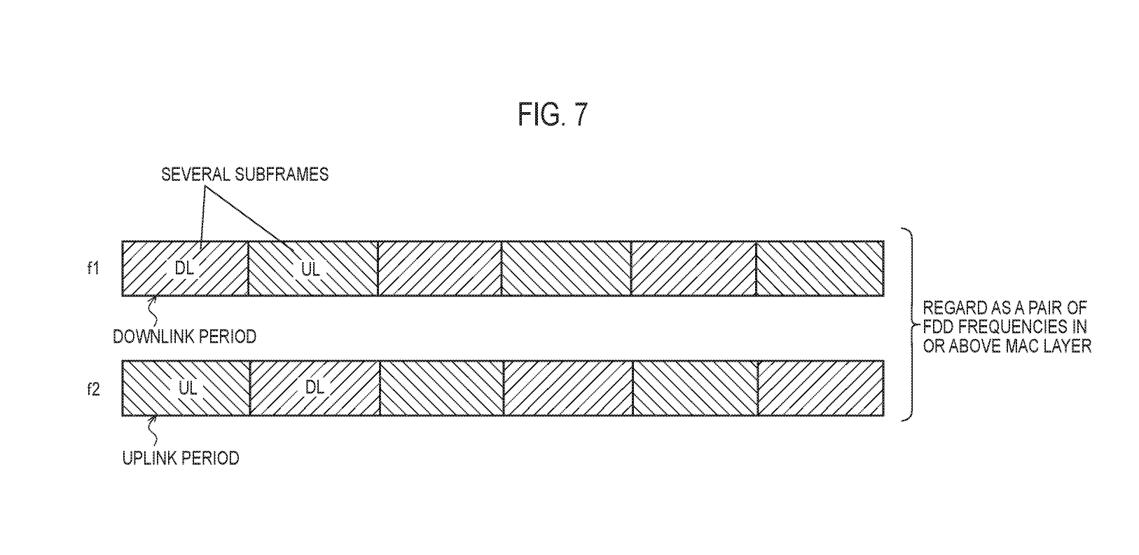

FIG. 7 is a diagram for describing an NCT according to the embodiment.

As shown in FIG. 6 and FIG. 7, the UE 100 performs the downlink communication and the uplink communication with the eNB 200 by using the pair of the frequency f1 and the frequency f2. The eNB 200 performs the downlink communication and the uplink communication with the UE 100 by using the pair of the frequency f1 and the frequency f2. Each of the frequency f1 and the frequency f2 is a TDD configuration (that is, TDD carrier) which alternately has a downlink period and an uplink period.

As shown in FIG. 7, one downlink period includes one subframe or a plurality of subframes. One uplink period includes one subframe or a plurality of subframes. Furthermore, a downlink period of the frequency f1 and an uplink period of the frequency f2 are set so as to be matched on a time axis, and an uplink period of the frequency f1 and a downlink period of the frequency f2 are set so as to be matched on the time axis. The UE 100 and the eNB 200 perform the downlink communication in each of the downlink periods of the frequency f1 and the frequency f2, and perform the uplink communication in each of the uplink periods of the frequency f1 and the frequency f2.

The UE 100 transmits, to the eNB 200, an uplink reference signal that is used in channel estimation in each of the uplink periods of the frequency f1 and the frequency f2. The eNB 200 receives, from the UE 100, the uplink reference signal that is used in the channel estimation in each of the uplink periods of the frequency f1 and the frequency f2.

Consequently, the eNB 200 is capable of performing the channel estimation for each of the frequency f1 and the frequency f2 on the basis of the uplink reference signal that is received from the UE 100. Thus, the eNB 200 is capable of acquiring each of the CSI of the frequency f1 and the frequency f2 by the eNB 200 itself without relying on the CSI feedback from the UE 100. Accordingly, it is possible to reduce overhead due to the CSI feedback. Furthermore, it is possible to introduce an advanced multi-antenna transmission such as MU-MIMO.

The uplink reference signal is a known signal sequence in the eNB 200 and is defined by a cyclic shift amount and a fundamental sequence. For example, in the fundamental sequence, a Zadoff-Chu sequence is applied, which has fixed amplitude in the both regions of time and frequency and in which cyclic-shifted sequences are orthogonal to each other. The uplink reference signal may be a sounding reference signal (SRS). In transmitting the SRS, frequency hopping is applied. That is, a transmission resource block of the SRS is switched for each transmission cycle of the SRS.

In the embodiment, a single cell identifier for regarding the pair of the frequency f1 and the frequency f2 as a frequency in a single FDD configuration (that is, a pair of FDD carriers) in or above the MAC layer is assigned to the pair. The cell identifier is a logical cell identifier and different from a physical cell identifier (PCI) that is a cell identifier in the physical layer.

The UE 100 and the eNB 200 perform TDD communication while switching a frequency in the physical layer, and perform communication by regarding that FDD communication is performed in or above the MAC layer. In the embodiment, the TDD and the FDD are switched between the physical layer and the MAC layer as a boundary.

Consequently, the UE 100 and the eNB 200 operate as if normal FDD communication is performed in or above the MAC layer unlike carrier aggregation (CA) in which two TDD carriers are bundled. Thus, a process that should be performed for each carrier in the CA can be made common in a pair of carriers. Furthermore, two TDD carriers are regarded as a pair of FDD carriers (corresponding to one component carrier), so that it is possible to realize the CA that uses 2×n of carriers when the maximum number of the component carriers of FDD in the CA is n. That is, it is possible to increase communication capacity by using the two times of carriers.

However, it is required that normal TDD communication that uses either one of the frequency f1 and the frequency f2 is available for a UE (legacy UE) which does not support the NCT. Thus, it should be noted that a different PCI is assigned to each of the frequency f1 and the frequency f2 respectively.

(2) Specific Example of Carrier Configuration

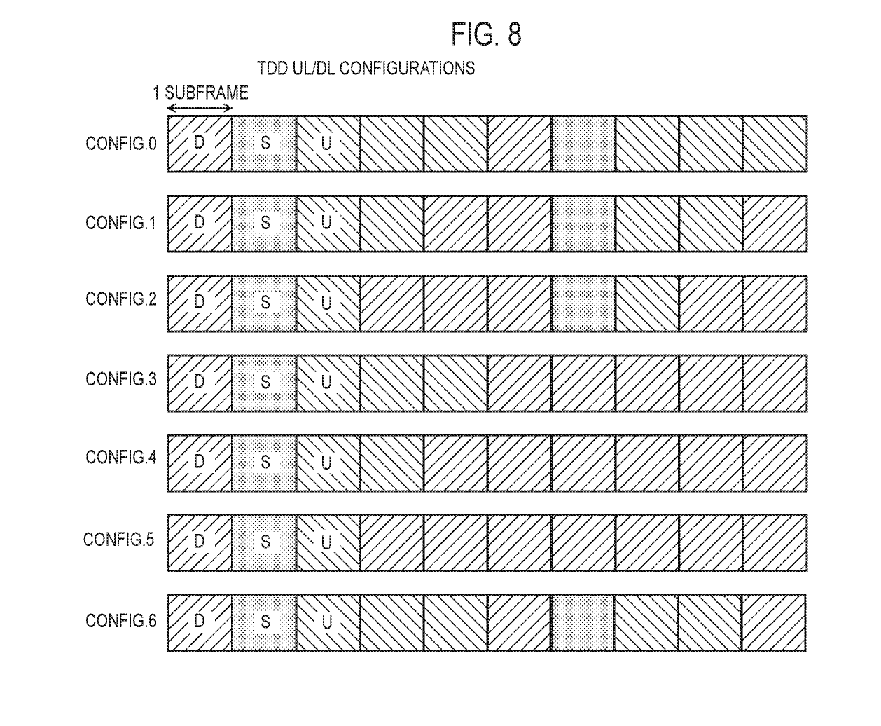

Next, a specific example of a carrier configuration shown in FIG. 7 (hereinafter, referred to as “TDD-FDD carrier configuration”) will be described. FIG. 8 is a diagram illustrating variations of a TDD frame configuration in LTE. As shown in FIG. 8, in the LTE, six TDD frame configurations (Configs.) are specified, in which balance of the downlink period and the uplink period is different.

In FIG. 8, a “D” subframe is a subframe that configures a downlink period, a “U” subframe is a subframe that configures an uplink period, and an “S” subframe is a special subframe that is used as a guard time.

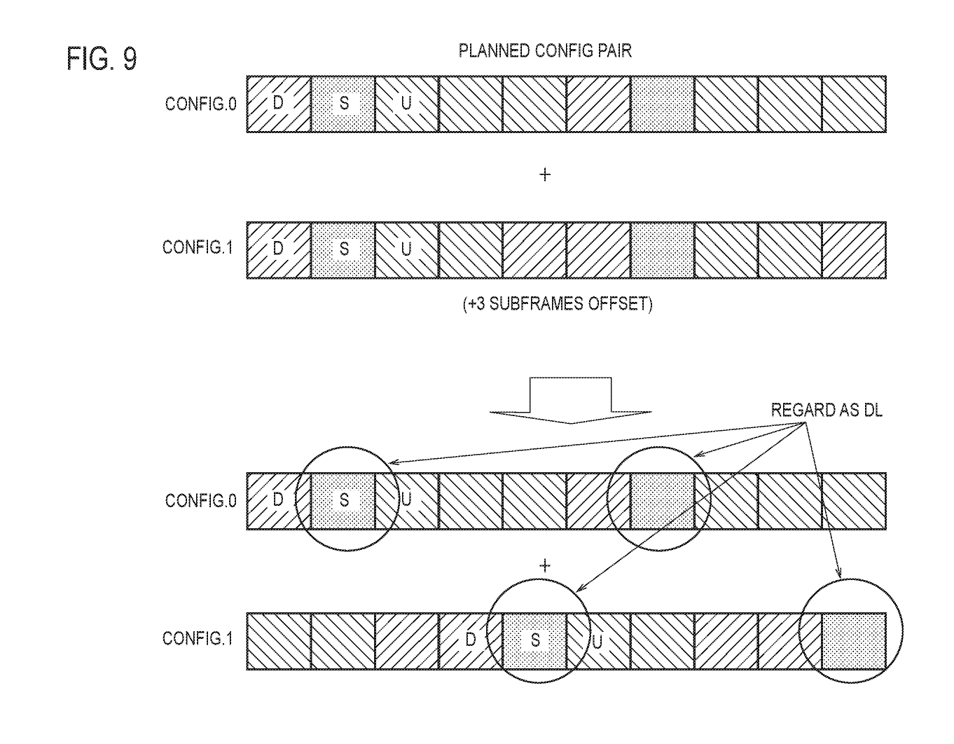

FIG. 9 is a diagram for describing an example of a combination of the TDD frame configuration. As shown in FIG. 9, a TDD frame configuration “0” is set to one carrier (for example, the frequency f1), and a TDD frame configuration “1” is set to the other carrier (for example, the frequency f2), then the carrier of the TDD frame configuration “1” is cyclic shifted after three subframes. That is, an offset of the three subframes is added.

Then, all of the “D” subframes match with a “U” subframe on the time axis. In a part in which an “S” subframe and a “U” subframe match on the time axis, it is possible to realize the TDD-FDD carrier configuration by using the “S” subframe by regarding the “S” subframe as a “D” subframe.

(3) Operation Sequence

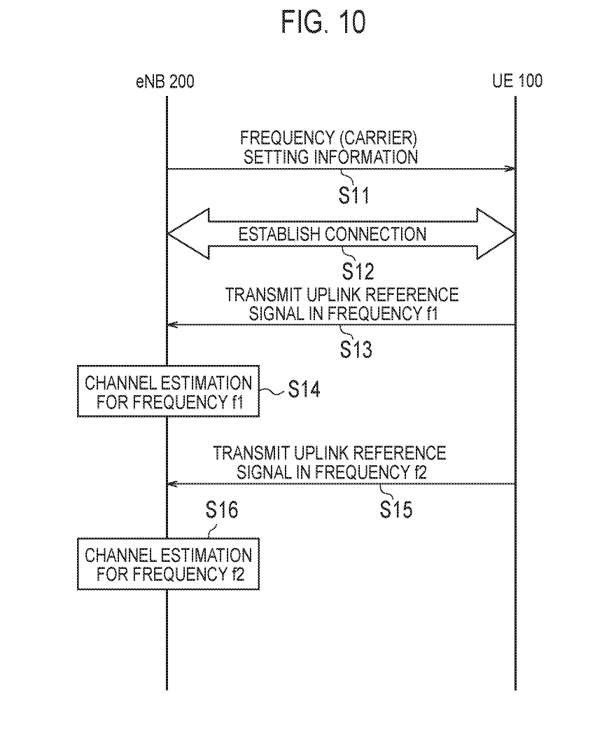

Next, an operation sequence according to the embodiment will be described. FIG. 10 is a sequence diagram according to the embodiment.

As shown in FIG. 10, in step S11, the eNB 200 transmits, to the UE 100, setting information indicating each setting of the frequency f1 and the frequency f2. The setting information is transmitted in a System Information Block type (SIB) 2 that is one type of system information broadcasted. Alternatively, the TDD-FDD carrier configuration may be indicated by a “TDD-Config” that is included in an SIB1. Furthermore, a frequency (the frequency f1, the frequency f2) to which the TDD-FDD carrier configuration is applied may be indicated by a “FreqBandIndicator” that is included in the SIB1. Alternatively, in a frequency to which the TDD-FDD carrier configuration is applied, the frequency may be made identifiable by applying a special arrangement of Primary Synchronization Signal (PSS)-Secondary Synchronization Signal (SSS).

Alternatively, in the case when a method of making the UE 100 recognize the normal TDD carrier upon initial access, then notifying the TDD-FDD carrier configuration afterwards is applied, instead of step S11, the TDD-FDD carrier configuration may be notified, to the UE 100, by an RRC message, for example, after the UE 100 establishes a connection.

In step S12, the UE 100 establishes a connection with the eNB 200. Here, the UE 100 and the eNB 200 assign, to the pair of the frequency f1 and the frequency f2, a single cell identifier for regarding the pair as a frequency in a single FDD configuration (that is, a set of pair band) in or above the MAC layer. Specifically, the eNB 200 assigns and notifies the identifier to the UE 100, and the eNB 200 also stores the identifier assigned to the UE 100. It is noted that the notification may be carried out depending on UE Capability, and may be notified later in accordance with a load of the eNB 200 or an application of MU-MIMO.

Furthermore, the UE 100 and the eNB 200 notify, from the MAC layer to the physical layer, that the TDD-FDD carrier configuration is applied, and notify a setting for the TDD-FDD carrier configuration. Further, a matter that can be made common (a measurement report, an HARQ process, an Ack/Nack, etc.) may be notified from the upper layer side (for example, the RRC layer) to the lower layer side (for example, the MAC layer). Hereinafter, while performing TDD communication while switching a frequency in the physical layer, the UE 100 and the eNB 200 perform communication by regarding that FDD communication is performed in or above the MAC layer.

In step S13, the UE 100 transmits an uplink reference signal to the eNB 200 by using the frequency f1.

In step S14, the eNB 200 performs channel estimation for the frequency f1 on the basis of the uplink reference signal that is received from the UE 100. In this way, the eNB 200 is capable of acquiring CSI of the frequency f1 by the eNB 200 itself without relying on CSI feedback from the UE 100.

In step S15, the UE 100 transmits an uplink reference signal to the eNB 200 by using the frequency f2.

In step S16, the eNB 200 performs channel estimation for the frequency f2 on the basis of the uplink reference signal received from the UE 100. In this way, the eNB 200 is capable of acquiring CSI of the frequency f2 by the eNB 200 itself without relying on CSI feedback from the UE 100.

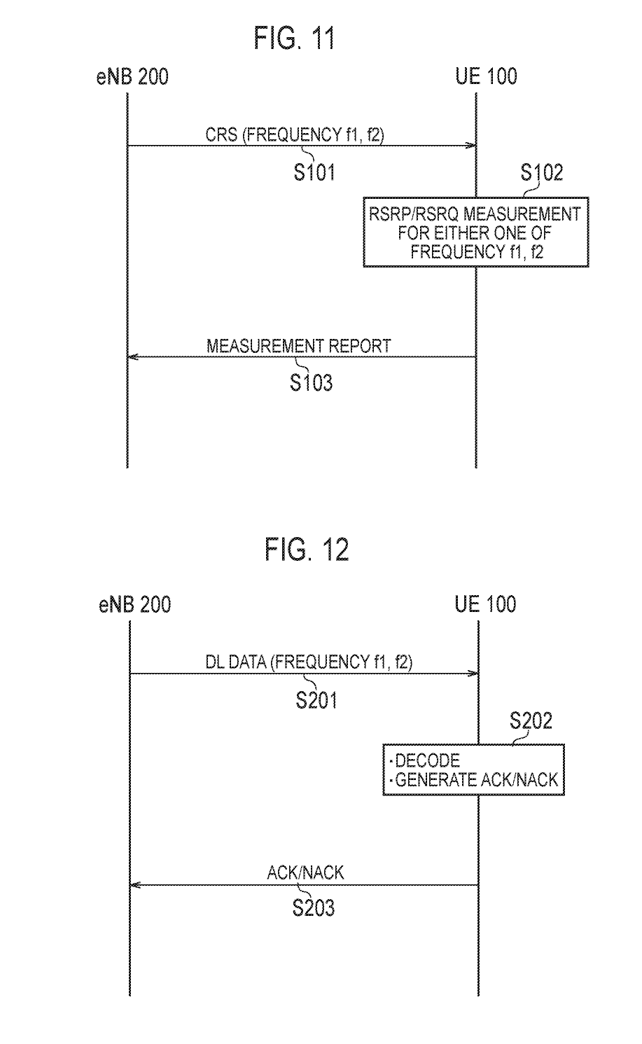

FIG. 11 is a sequence diagram illustrating a measurement report procedure according to the embodiment.

As shown in FIG. 11, in step S101, the eNB 200 transmits a downlink reference signal in each of the downlink periods of the frequency f1 and the frequency f2. The UE 100 receives the downlink reference signal from the eNB 200 in each of the downlink periods of the frequency f1 and the frequency f2. Specifically, the UE 100 receives the downlink reference signal from a serving cell and a neighboring cell.

In step S102, the UE 100 measures received power of the downlink reference signal (RSRP) and/or reception quality of the downlink reference signal (RSRQ) for either one of the frequency f1 and the frequency f2.

In step S103, the UE 100 transmits, to the eNB 200, a measurement report including the RSRP and/or the RSRQ. Here, the UE 100 transmits, to the eNB 200, a measurement report common in the pair of the frequency f1 and the frequency f2. The eNB 200 receives the measurement report from the UE 100.

FIG. 12 is a sequence diagram illustrating an Ack/Nack report procedure according to the embodiment.

As shown in FIG. 12, in step S201, the eNB 200 transmits downlink user data to the UE 100 in each of the downlink periods of the frequency f1 and the frequency f2. The UE 100 receives the downlink user data from the eNB 200 in each of the downlink periods of the frequency f1 and the frequency f2.

In step S202, the UE 100 decodes the downlink user data, and then generates an Ack when the decoding is successful and generates a Nack when the decoding is unsuccessful.

In step S203, the UE 100 transmits the Ack/Nack for the downlink user data to the eNB 200. Here, the UE 100 transmits, to the eNB 200, an Ack/Nack common in the pair of the frequency f1 and the frequency f2. The eNB 200 receives the Ack/Nack from the UE 100.

Specifically, an Ack/Nack for downlink communication in the frequency f1 may be returned in uplink communication in the frequency f1 or may be returned in uplink communication in the frequency f2. The LTE system has a specification in which the Ack/Nack is returned four subframes after receiving the data, and thus, for example, in a subframe that is four subframes after a downlink communication subframe in a certain frequency f1, the Ack/Nack may be returned in the frequency f1 when a first frequency is a subframe for uplink communication, and may be returned in the frequency f2 when the frequency 2 is a subframe for uplink communication.

### Summary of Embodiment

As described above, each of the frequency f1 and the frequency f2 has the TDD configuration which alternately has the downlink period and the uplink period. Furthermore, the downlink period of the frequency f1 and the uplink period of the frequency f2 are set so as to be matched on the time axis, and the uplink period of the frequency f1 and the downlink period of the frequency f2 are set so as to be matched on the time axis. The UE 100 and the eNB 200 perform the downlink communication in each of the downlink periods of the frequency f1 and the frequency f2, and perform the uplink communication in each of the uplink periods of the frequency f1 and the frequency f2.

The UE 100 transmits, to the eNB 200, an uplink reference signal that is used in channel estimation in each of the uplink periods of the frequency f1 and the frequency f2. The eNB 200 receives, from the UE 100, the uplink reference signal that is used in the channel estimation in each of the uplink periods of the frequency f1 and the frequency f2.

Consequently, the eNB 200 is capable of performing the channel estimation for each of the frequency f1 and the frequency f2 on the basis of the uplink reference signal that is received from the UE 100. Thus, the eNB 200 is capable of acquiring each of CSI of the frequency f1 and the frequency f2 by the eNB 200 itself without relying on CSI feedback from the UE 100. Accordingly, it is possible to reduce overhead due to the CSI feedback. Furthermore, it is possible to introduce an advanced multi-antenna transmission such as MU-MIMO.

Furthermore, a single cell identifier (logical cell identifier) for regarding the pair of the frequency f1 and the frequency f2 as a frequency in a single FDD configuration (a pair of frequencies) in or above the MAC layer is assigned to the pair.

Consequently, the UE 100 and the eNB 200 operate as if normal FDD communication is performed in or above the MAC layer unlike the carrier aggregation (CA) in which two TDD carriers are bundled. Thus, a process that should be performed for each carrier in the CA can be made common in a pair of carriers. Furthermore, two TDD carriers are regarded as a pair of FDD carriers (one component carrier), so that it is possible to realize the CA that uses 2×n of carriers when the maximum number of the component carriers of FDD in the CA is n. For example, in an LTE-Advanced system, it is possible, even in the TDD, to perform the CA at a maximum bandwidth of 200 MHz obtained when the uplink and the downlink combined.

### Other Embodiments

In above-described embodiment, the TDD and the FDD are switched between the physical layer and the MAC layer as the boundary. However, the boundary may be set between the MAC layer and the RLC layer, may be set between the MAC layer and the RLC layer, may be set between the RLC layer and the PDCP layer, or may be set between the PDCP layer and the RRC layer.

In each of the above-described embodiments, as one example of a cellular communication system, the LTE system is described; however, the present invention is not limited to the LTE system, and the present invention may be applied to systems other than the LTE system.

It is noted that the entire content of Japanese Patent Application No. 2013-202764 (filed on Sep. 27, 2013) is incorporated in the present description by reference.

### INDUSTRIAL APPLICABILITY

According to the present invention, it is possible to reduce overhead due to CSI feedback.

Furthermore, according to the present invention, it is possible to increase the maximum frequency width available when using CA in a TDD carrier. For example, in an LTE-Advanced system, it is possible, even in TDD, to perform CA at a maximum bandwidth of 200 MHz obtained when the uplink and the downlink combined.

1. A user terminal that performs downlink communication and uplink communication with a base station by using a pair of a first frequency and a second frequency, wherein
each of the first frequency and the second frequency has a TDD configuration that alternately has a downlink period and an uplink period,
the downlink period of the first frequency and the uplink period of the second frequency are set so as to be matched on a time axis, and the uplink period of the first frequency and the downlink period of the second frequency are set so as to be matched on a time axis, comprising
a controller configured to perform the downlink communication in each of the downlink periods of the first frequency and the second frequency, and perform the uplink communication in each of the uplink periods of the first frequency and the second frequency.

2. The user terminal according to claim 1, further comprising: a transmitter configured to transmit, to the base station, an uplink reference signal that is used in channel estimation in each of the uplink periods of the first frequency and the second frequency.

3. The user terminal according to claim 1, wherein a single cell identifier for regarding the pair of the first frequency and the second frequency as a frequency in a single FDD configuration in or above a MAC layer is assigned to the pair of the first frequency and the second frequency.

4. The user terminal according to claim 1, further comprising: a receiver configured to receive a downlink reference signal from the base station in each of the downlink periods of the first frequency and the second frequency; and
a transmitter configured to transmit, to the base station, a measurement report that includes received power and/or reception quality of the downlink reference signal, wherein
the transmitter transmits, to the base station, the measurement report common in the pair of the first frequency and the second frequency.

5. The user terminal according to claim 1, further comprising: a receiver configured to receive downlink user data from the base station in each of the downlink periods of the first frequency and the second frequency; and
a transmitter configured to transmit an Ack/Nack for the downlink user data to the base station, wherein
the transmitter transmits, to the base station, the Ack/Nack common in the pair of the first frequency and the second frequency.

6. A base station that performs downlink communication and uplink communication with a user terminal by using a pair of a first frequency and a second frequency, wherein
each of the first frequency and the second frequency has a TDD configuration that alternately has a downlink period and an uplink period,
the downlink period of the first frequency and the uplink period of the second frequency are set so as to be matched on a time axis, and the uplink period of the first frequency and the downlink period of the second frequency are set so as to be matched on a time axis, comprising
a controller configured to perform the downlink communication in each of the downlink periods of the first frequency and the second frequency, and perform the uplink communication in each of the uplink periods of the first frequency and the second frequency.

7. The base station according to claim 6, further comprising: a receiver configured to receive, from the user terminal, an uplink reference signal that is used in channel estimation in each of the uplink periods of the first frequency and the second frequency.

8. The base station according to claim 6, wherein a single cell identifier for regarding the pair of the first frequency and the second frequency as a frequency in a single FDD configuration in or above a MAC layer is assigned to the pair of the first frequency and the second frequency.

9. The base station according to claim 6, further comprising: a transmitter configured to transmit a downlink reference signal in each of the downlink periods of the first frequency and the second frequency; and
a receiver configured to receive, from the user terminal, a measurement report that includes received power and/or reception quality of the downlink reference signal, wherein
the receiver receives, from the user terminal, the measurement report common in the pair of the first frequency and the second frequency.

10. The base station according to claim 6, further comprising: a transmitter configured to transmit downlink user data to the user terminal in each of the downlink periods of the first frequency and the second frequency; and
a receiver configured to receive an Ack/Nack for the downlink user data from the user terminal, wherein
the receiver receives, from the user terminal, the Ack/Nack common in the pair of the first frequency and the second frequency.

11. A processor provided in a user terminal that performs downlink communication and uplink communication with a base station by using a pair of a first frequency and a second frequency, wherein
each of the first frequency and the second frequency has a TDD configuration that alternately has a downlink period and an uplink period,
the downlink period of the first frequency and the uplink period of the second frequency are set so as to be matched on a time axis, and the uplink period of the first frequency and the downlink period of the second frequency are set so as to be matched on a time axis, and
the processor performs the downlink communication in each of the downlink periods of the first frequency and the second frequency, and performs the uplink communication in each of the uplink periods of the first frequency and the second frequency.
